(19) United States
(12) Patent Application Publication
(10) Pub. No.: US 2007/0109095 A1
(43) Pub. Date: May 17, 2007

(54) Insurance safety device

(76) Inventor: Carol Ann Robbins, Carrollton, TX (US)

Correspondence Address: CAROL ANN ROBBINS, 3258 NORTHVIEW, CARROLLTON, TX, 75007, US

(21) Appl. No.: 11/274,801

(22) Filed: Nov. 16, 2005

(51) Int. Cl. B60R 25/00; B60R 25/10

(52) U.S. Cl. 340/5.72; 340/426.11

(57) ABSTRACT

The Insurance Safety Device is a device that connects to the ignition and regulates the start up of the vehicle with the use of a computer chip or strip located in or on an insurance card or the driver's license. The chip or strip has the auto insurance and personal driver's license information of an auto user. The scanning device reads and stores the user's information. While running on real time, when the card or driver's license is swiped in the safety device, the information on the chip/strip is read. The safety device receives current auto insurance information status provided from a web site that the insurance companies only would have access to for inputting their insured's auto insurance and driver licensing information. If there are any problems with the auto user's insurance or driver's license, the device will not allow the vehicle to start.

### BACKGROUND OF THE INVENTION

The Insurance Safety Device is intended for the use of the insurance companies. The Insurance Safety Device would fulfill the need for providing current insurance and license information before operating a motor vehicle. The appealing features of the Insurance Safety Device are the insurance savings, safety and security. Instead of allowing motorist with no insurance or a suspended licenses or no license to drive, this device would require current insurance and driver's license each time a motor vehicle is started. This would automatically filter out those who are uninsured and unauthorized to operate a moving vehicle. It would help reduce the risk of accidents involving high-risk drivers, while reducing the over all cost of insurance for safe, law abiding motorist. For further use, this device could possible help to deter auto theft using the information stored in the reader.

According to the Standard Industrial Classification (SIC) system, the Insurance Safety Device would fall under SIC code 3714—Manufacturers of Motor Vehicle Parts and Accessories.

Under the North American Industrial Classification System (NAICS) the classification code is 336322—Manufacturers of Miscellaneous Motor Vehicle Electrical and Electronic Equipment.

### BRIEF SUMMARY OF THE INVENTION

The Insurance Safety Device is an automotive device that connects to the ignition and regulates the start up of a vehicle by the use of a computer chip or magnetic strip located in or on an insurance card or located in or on an individual driver's license. The computer chip or strip would hold the auto insurance and personal drivers license information of the auto user. The reader would read and store the drivers' insurance and personal driver licensing information. It also receives the users insurance company and licensing status from an outside source. If any problems were detected with the insurance or the individual's license information, the vehicle would not be permitted to start.

### DETAILS OF DESCRIPTION OF THE INVENTION

The System would be comprised primarily of a computer chip or a magnetic strip housed in/on an insurance card or drivers license. An electronic scanner, a control switch, insulated input wiring and mounting hardware. The scanner, while reading the information would be capable of running on real time when reading the insurance card or driver's license, that houses computer chip or magnetic strip. Also while running on real time, the scanner receives the current insurance and driver's licensing information provided from the outside data base source. The scanner would be wired to a control switch in the ignition system of the vehicle to regulate the start-up of the vehicle. Before the vehicle can be used, the motorist must first swipe the insurance card or drivers license through a slot opening on the scanner. The coded electronic information on the computer chip or magnetic strip would be immediately interpreted. As long as the driver's license and insurance is current, a green light on the scanner will show and the ignition to start the engine will activate. If an individual had no auto insurance or an expired or a suspended license, the reader will display a message indicating the problem of no insurance or driver's license problem. A red light will then show and the ignition circuit would be disabled preventing the engine from starting.

What I claim as my invention is an Automotive ignition control that is regulated by a computer chip or magnetic strip and the outside data base source which would disable the ignition start-up of would be drivers who have no auto insurance coverage and/or no license or a suspended license and is used for auto insurance purposes:

1) Computer chip or magnetic strip means a pre-program small thin electronic device or a long thin area that stores the card holder or licensed holder insurance and driver's license information

2) Receiver means the device housed within the reader that converts information received from the outside data base source for vehicle operational use

3) Scanner means an electronic device that houses a vehicle VIN# and read the personal insurance and license information stored on the computer chip or magnetic strip. It would also store the last ten driver's license users of that a particular motor vehicle.

4) Out-side information source means an information web-site that houses and sends to the safety device information such as the insurance company, an individual's insurance status and personal driver's licensing information
